(19) United States
(12) Patent Application Publication
(10) Pub. No.: US 2011/0001255 A1
(43) Pub. Date: Jan. 6, 2011

(54) Vacuum Removal of Entrained Gasses In Extruded, Foamed Polyurethane

(75) Inventor: Marc-Andre Tardif, Atlanta, GA (US)

Correspondence Address: McKeon Meunier Carlin & Curfman LLC, 817 W. Peachtree Street, Suite 900, Atlanta, GA, 30308, US

(73) Assignee: Boral Material Technologies Inc., San Antonio, TX (US)

(21) Appl. No.: 12/830,692

(22) Filed: Jul. 6, 2010

Related U.S. Application Data
(60) Provisional application No. 61/223,159, filed on Jul. 6, 2009.

(51) Int. Cl. B29C 47/76; B29C 47/00

(52) U.S. Cl. 264/45.9

(57) ABSTRACT

Methods for forming foamed polyurethane composite materials in an extruder including a vacuum section are described. One method includes introducing a polyol, a di- or poly-isocyanate, and an inorganic filler to a first section of an extruder and mixing the components. After mixing, the composite material is advanced to a second section of the extruder, which is maintained at a vacuum pressure. The composite material can begin foaming in the second section and then be extruded from the output end of the extruder. The vacuum pressure of the second section removes non-foaming related gasses entrained in the composite material. A further method includes directing the extruded composite material into a mold.

### CROSS-REFERENCE TO RELATED APPLICATIONS

The present application claims priority to U.S. Provisional Patent Application No. 61/223,159, filed Jul. 6, 2009, which is incorporated herein by reference in its entirety.

### BACKGROUND

During composite mixing or polymer formation in an extruder, various gasses present in the extruder can become mixed into the polymer created and form entrained gaseous pockets. These pockets of gasses can create areas of weakness or non-uniform density in a product made from the polymer formulated in the extruder. Foamed products created in an extruder can include these entrained gaseous pockets in addition to their desired foam pockets. The ability to remove entrained gaseous pockets from composites including foamed composites would be helpful in creating products with uniform properties.

### SUMMARY

Methods for forming a foamed polyurethane composite material in an extruder are described. A first method of forming a foamed polyurethane composite material in an extruder includes the step of introducing a polyol, a di- or poly-isocyanate, and an inorganic filler to a first section of an extruder. After introduction, the polyol, the di- or poly-isocyanate, and the inorganic filler are mixed in the first section to produce a composite material. Next the composite material is advanced to a second section of the extruder that is maintained at a vacuum pressure. The composite material can begin foaming in the second section of the extruder. Finally, the composite mixture is extruded from an output end of the extruder. The vacuum pressure in the second section removes non-foaming related gasses entrained in the composite material.

A further method involves forming a molded article using a foamed polyurethane composition. The method includes the step of introducing a polyol, a di- or poly-isocyanate, and an inorganic filler to a first section of an extruder. After introduction, the polyol, the di- or poly-isocyanate, and the inorganic filler are mixed in the first section to produce a composite material. Next the composite material is advanced to a second section of the extruder that is maintained at a vacuum pressure. The composite material is foamed in the second section of the extruder. Finally, the composite mixture is extruded from an output end of the extruder. The vacuum pressure in the second section removes non-foaming related gasses entrained in the composite material.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic of an extruder system with a section maintained at a vacuum pressure.

FIG. 2 is a schematic of an molding system including an extruder system with a section maintained at a vacuum pressure and a mold into which extruded material is directed.

FIG. 3 is a schematic of a control system for use of the vacuum in the extruder system.

Like reference symbols in the various drawings indicate like elements.

### DETAILED DESCRIPTION

Methods for forming foamed polyurethane composite materials in an extruder are described herein. One method includes introducing a polyol, a di- or poly-isocyanate, and an inorganic filler to a first section of an extruder and mixing the components. After mixing, the composite material is advanced to a second section of the extruder, which is maintained at a vacuum pressure. The composite material can begin foaming in the second section then extruded from the output end of the extruder. The vacuum pressure of the second section removes non-foaming related gasses entrained in the composite material. A further method includes introducing a polyol, a di- or poly-isocyanate, and an inorganic filler to a first section of an extruder and mixing the components. After mixing, the composite material is advanced to a second section of the extruder, which is maintained at a vacuum pressure. The composite material is foamed in the second section then extruded from the output end of the extruder. The extruded composite can then be directed into a mold. The vacuum pressure of the second section removes non-foaming related gasses entrained in the composite material.

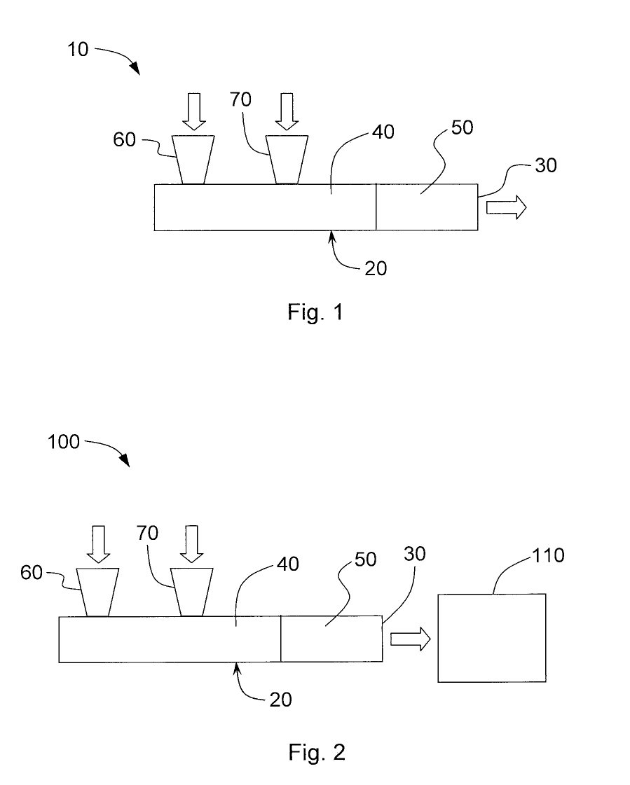

Components of an extruder system 10 useful in implementing the methods described herein are shown in FIG. 1. Extruder system 10 includes an extruder barrel 20 with an output end 30, a first section 40, a second section 50, a first input 60, and a second input 70. Polyol, isocyanate, and inorganic filler are introduced to the first extruder section 40 through the first input 60. Fiber and other materials can be introduced to the first extruder section 40 through the second input 70 as desired. The second section 50 is maintained at a vacuum pressure using a vacuum source such that the vacuum pressure in the second extruder section removes non-foaming related gasses entrained in the composite material. As used herein, the phrase removes non-foaming related gasses is intended to indicate that the method is intended to remove gasses that were entrained in the composite material prior to the foaming reaction. However, the removal of a limited amount of gasses present within the composite material due to foaming is intended to be within the scope of the appended claims.

A vacuum can be maintained in the second section 50, for example, by the use of a conventional vacuum pump or vacuum generator. The use and selection of vacuum pumps or vacuum generators for use with an extruder is well known to those of skill in the art. An example of a useful vacuum generator is model VDF 200 from Vaccon Vacuum Products (Vaccon Co., Inc.; Medfield, Mass.). As used herein, the term vacuum is intended to mean a pressure less than atmospheric pressure (i.e., 29.92 inches of mercury (inHg)). Thus, a pressure of less than 29.92 inHg indicates a vacuum pressure. Vacuum pressures of between 1 inHg and 25 inHg, 2 inHg and 20 inHg, 5 inHg and 15 inHg, and 8 inHg and 12 inHg are useful with the methods described herein. Further, vacuum pressures of 25 inHg or less, 20 inHg or less, 15 inHg or less, 12 inHg or less, 10 inHg or less, or 5 inHg or less are also useful. A vacuum pressure of about 10 inHg is particularly useful.

Components of a further extruder system 100 useful in implementing the methods described herein are shown in FIG. 2. The extruder system 100 includes an extruder barrel 20 with an output end 30, a first section 40, a second section 50, a first input 60, and a second input 70 each as described above. The extruder system 100 further includes a mold 110 into which the composite mixture extruded from the output end of the extruder 30 is directed. Polyol, isocyanate, and inorganic filler are introduced to the first extruder section 40 through the first input 60. Fiber and other materials can be introduced to the first extruder section 40 through the second input 70 as desired. The second section 50 is maintained at a vacuum pressure using a vacuum source such that the vacuum pressure in the second extruder section removes non-foaming related gasses entrained in the composite material.

The types of molds useful with extruded polymer composite materials are well known to those of skill in the art. Extruded polymer composite materials are often extruded through a profile die that imparts a shape, such as a tubular shape, to the extruded polymer composite material. Additionally, an extruded polymer composite material can be directed into a mold cavity to adopt the shape of the mold through compression or expansion. With the use of molds external to an extruder, a user will account for the continuous nature of the extruded composite material, i.e., the material will continue to be extruded and material can be lost if the transition time between the availability of mold cavities is not accounted for. One useful molding technique for extruded composite material is to use a continuous mold. One example of a continuous mold is a continuous belt mold. A continuous belt mold is a cavity formed between two or more belts that provide a shape for the extruded material to adopt. The forming belts wrap around rollers or similar devices and return to continuously form a mold cavity.

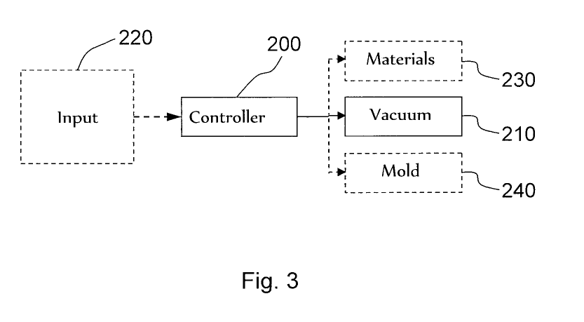

As shown in FIG. 3, a controller 200 can be used to control the vacuum in the second section 50. The controller 200 is operatively interconnected with a vacuum device 210, such as a vacuum pump. The controller 200 has hardware and/or software configured for operation of the vacuum device 210, and may comprise any suitable programmable logic controller or other control device, or combination of control devices, that is programmed or otherwise configured to perform the process described herein. The controller 200 can control the vacuum device 210 based on an input signal 220. The input signal 210 can be a desired pressure for the second section 50. Additionally, the controller 200 can control or provide instructions to one or more devices controlling the addition of materials 230 to the extruder. Further, the controller 200 can control or provide instructions to a mold control system 240.

Various foamed polyurethane composite materials may be created using an extruder and the methods described herein. Extrusion allows for thorough mixing of the various components of the composite material. The extruder components may be configured in various ways to provide a substantially homogeneous mixture of the various components of the composite material. The various components of a foamed polyurethane composite material (e.g., polyol, di- or poly-isocyanate, and inorganic filler) may be added in different orders and at different positions in an extruder through various input devices (e.g., hoppers, feed chutes, or side feeders). As used herein, the term composite material is intended to include the components of a polymeric material made in situ in an extruder. Hence, a method step referring to introducing component materials to an extruder includes the addition of components that will react to form a polymeric material in situ in an extruder. Such reactions may be controlled by various additives and reaction conditions. For example, surfactants may be used to control cell structure and catalysts may be used to control reaction rates. An example of a polyurethane composite material formed in situ may include one or more of a polyol, a monomeric or oligomeric di- or poly-isocyanate, an inorganic filler, a fibrous material, a catalyst, a surfactant, a colorant, a coupling agent, and other various additives. The various materials added to an extruder may be metered into the extruder through metering devices or other means. Continuous feeding of the respective components of the polymeric composite material results in a continuous process of extruding the polymeric composite material. Extruder technology is well known to those of skill in the art.

Fillers as used with the methods described herein include particulate material. With the addition of such fillers, the composite materials may still retain good chemical and mechanical properties. These properties of the composite material allow for its use in building materials and other structural applications. Advantageously, the composite material may contain large loadings of filler content without substantially sacrificing the intrinsic structural, physical, and mechanical properties of the polymer. Examples of fillers useful with the compositions described herein include, but are not limited to, fly ash and bottom ash; wollastonite; ground waste glass; granite dust; calcium carbonate; perlite; barium sulfate; slate dust; gypsum; talc; mica; montmorillonite minerals; chalk; diatomaceous earth; sand; bauxite; limestone; sandstone; microspheres; porous ceramic spheres; gypsum dihydrate; calcium aluminate; magnesium carbonate; ceramic materials; pozzolanic materials; zirconium compounds; vermiculite; pumice; zeolites; clay fillers; silicon oxide; calcium terephthalate; aluminum oxide; titanium dioxide; iron oxides; calcium phosphate; sodium carbonate; magnesium sulfate; aluminum sulfate; magnesium carbonate; barium carbonate; calcium oxide; magnesium oxide; aluminum hydroxide; calcium sulfate; barium sulfate; lithium fluoride; calcium hydroxide; and other solid waste materials. Other acceptable fillers will be known to those of skill in the art. Fly ash is useful because it is uniform in consistency and contains carbon, which can provide some desirable weathering properties to the product due to the inclusion of fine carbon particles which are known to provide weathering protection to plastics, and the effect of opaque ash particles which block UV light. Ground glass (such as window or bottle glass) is also useful as it absorbs less resin, decreasing the cost of the composite.

Particulate materials with a broad particle size distribution having multiple modes can advantageously be used with the composites described herein. Examples of such particulate materials can be found in U.S. Pat. Nos. 6,916,863 and 7,241,818, which are incorporated herein by reference in their entirety. Specifically, a fly ash filler or filler blend having a particle size distribution with at least three modes can be used. Preferably, the particle size distribution includes a first mode having a median particle diameter from 0.3 to 1.0 microns, a second mode having a median particle diameter from 10 to 25 microns, and a third mode having a median particle diameter from 40 to 80 microns. The particle size distribution also preferably includes 11-17% of the particles by volume in the first mode, 56-74% of the particles by volume in the second mode, and 12-31% of the particles by volume in the third mode. Moreover, the ratio of the volume of particles in the second and third modes to the volume of particles in the first mode is preferably from about 4.5 to about 7.5. A filler comprising a fly ash having a particle size distribution having at least three modes can further include one or more additional fillers other than the fly ash.

The composite materials described herein additionally comprise blends of various fillers. For example, coal fly ash and bottom ash can be used together as a mixture. Composite materials utilizing filler blends may exhibit better mechanical properties such as impact strength, flexural modulus, and flexural strength. A further advantage in using filler blends is compatibility in particle size distribution that can result in higher packing ability in certain blends.

The composite materials described herein can comprise about 20 to about 95 weight percent of inorganic filler, which includes, for example, approximately 20, 25, 30, 35, 40, 42, 44, 46, 48, 50, 52, 54, 56, 58, 60, 62, 64, 66, 68, 70, 72, 74, 76, 78, 80, 82, 84, 86, 88, 90, 92, or 94 weight percent of filler. These amounts are based on the total amount of filler used, and only one type of filler (e.g., fly ash), or filler blends (e.g. fly ash and dust) can be used. In certain embodiments, the polymeric composite material may contain the filler in an amount within a range formed by two of the foregoing approximate weight percents. Additionally, the composite materials can comprise about 30 to about 90 weight percent of inorganic filler, about 40 to about 87.5 weight percent of inorganic filler, about 50 to about 85 weight percent of inorganic filler, about 60 to about 82.5 weight percent, or about 65 to about 80 weight percent of inorganic filler. As used herein, weight percent refers to the relative weight of the filler component compared to the total weight of the composite material.

Fibers can also be added (e.g., in the first section 40 of the extruder such that the composite materials possess good chemical and mechanical properties as described regarding the use of fillers). Exemplary fibers can include reinforcing fibers and can include fibers such as chopped fiberglass (chopped before or during mixing in an extruder), rovings, basalt, PVA fibers, carbon fibers, linear tows, wollastonite, or fabrics. The reinforcing fibers can range in length, for example, from about 0.1 in. to about 2.5 in, from about 0.2 in to about 2 in., from about 0.25 in. to about 1 in., or from about 0.25 in. to about 0.5 in. Such fibers can, for example, be fed from a spindle or otherwise provided as known to those of skill in the art.

The reinforcing fibers give the material added strength (flexural, tensile, and compressive), increase its stiffness, and provide increased toughness (impact strength or resistance to brittle fracture). The use of rovings or tows increases flexural stiffness and creep resistance. Specifically, the dispersed reinforcing fibers may be bonded to the polymeric matrix phase, thereby increasing the strength and stiffness of the resulting material. This enables the material to be used as a structural synthetic lumber, even at relatively low densities (e.g., about 20 to about 60 lb/ft³).

Composite materials as described herein may be formed with a desired density to provide structural stability and strength. In addition, the composite material can be easily tuned to modify its properties by, e.g., adding oriented fibers to increase flexural stiffness, or by adding pigment or dyes to hide the effects of scratches. Also, such composite materials may also form a “skin,” i.e., a tough, slightly porous layer that covers and protects the more porous material beneath. Such skin can be tough, continuous, and highly adherent, and can provide excellent water and scratch resistance.

As discussed above, one of the monomeric components used to form a foamed polyurethane composite material is a poly- or di-isocyanate (an aromatic diisocyanate or polyisocyanate may be used). The poly- or di-isocyanate can be monomeric or polymeric. In certain embodiments methylene diphenyl diisocyanate (MDI) is used. The MDI can be MDI monomer, MDI oligomer, or mixtures thereof. The particular MDI used can be selected based on the desired overall properties, such as the amount of foaming, strength of bonding to the inorganic particulates, wetting of the inorganic particulates in the reaction mixture, strength of the resulting composite material, and stiffness (elastic modulus).

Suitable MDI compositions include those having viscosities ranging from about 25 to about 200 cp at 25° C. and NCO contents ranging from about 30% to about 35%. Generally, isocyanates are used that provide at least 1 equivalent NCO group to 1 equivalent OH group from the polyols, preferably with about 5% to about 10% excess NCO groups. Suitable examples of aromatic polyisocyanates include 4,4-diphenylmethane diisocyanate (methylene diphenyl diisocyanate), 2,4- or 2,6-toluene diisocyanate (including mixtures thereof), p-phenylene diisocyanate, tetramethylene and hexamethylene diisocyanates, 4,4-dicyclohexylmethane diisocyanate, isophorone diisocyanate, and mixtures of 4,4-phenylmethane diisocyanate and polymethylene polyphenylisocyanate. In addition, triisocyanates such as, 4,4,4-triphenylmethane triisocyanate; 1,2,4-benzene triisocyanate; polymethylene polyphenyl polyisocyanate; and methylene polyphenyl polyisocyanate, may be used. Isocyanates are commercially available from Bayer Corporation (Pittsburgh, Pa.) under the trademarks MONDUR and DESMODUR. Isocyanates suitable for use with the composites described herein include Bayer MRS-4, Bayer MR Light, Dow PAPI 27 (Dow Chemical Company; Midland, Mich.), Bayer MR5, Bayer MRS-2, and Huntsman Rubinate 9415 (Huntsman Polyurethanes; Geismar, La.).

As indicated above, the isocyanate is reacted with one or more polyols. In general, the ratio of isocyanate to polyol (isocyanate index), based on equivalent weights (OH groups for polyols and NCO groups for isocyanates) is generally in the range of about 0.5:1 to about 1.5:1. Additionally, the isocyanate index can be from about 0.8:1 to about 1.1:1, from about 0.8:1 to about 1.2:1, or from about 1.05:1 to about 1.1:1. Ratios in these ranges provide good foaming and bonding to inorganic particulates, and yields low water pickup, fiber bonding, heat distortion resistance, and creep resistance properties. A particularly useful isocyanate index is from 1.05:1 to 1.1:1.

Polyols useful with the methods described herein may be single monomers, oligomers, or blends. Mixtures of polyols can be used to influence or control the properties of the resulting composite material. The properties, amounts, and number of polyols used may be varied to produce a desired polyurethane composite material. Useful polyols include polyester and polyether polyols. Polyether polyols are commercially available from, for example, Bayer Corporation (Pittsburgh, Pa.) under the trademark MULTRANOL. Polyols useful with the methods described herein include polyether polyols, such as MULTRANOL, including MULTRANOL 3400 and MULTRANOL 4035, ethylene glycol, polypropylene glycol, polyethylene glycol, diethylene glycol, triethylene glycol, dipropylene glycol, glycerol, 2-pentane diol, pentaerythritol adducts, 1-trimethylolpropane adducts, trimethylolethane adducts, ethylenediamine adducts, diethylenetriamine adducts, 2-butyl-1,4-diol, neopentyl glycol, 1,2-propanediol, pentaerythritol, mannitol, 1,6-hexanediol, 1,3-buytylene glycol, hydrogenated bisphenol A, polytetramethyleneglycolethers, polythioethers, and other di- and multi-functional polyethers and polyester polyethers, and mixtures thereof. Additionally, plant-based polyols (such as castor, canola, and soy oil polyols), polycarbonate polyols, phenolic polyols, and acrylic polyols can be used. Examples of plant based polyols useful with the methods described herein include ECOPOL 122, ECOPOL 123, ECOPOL 124, ECOPOL 131, and ECOPOL 132, which are aromatic polyester polyols based on soybean oil grafted with polyethylene terephthalate (PET) from ECOPUR Industries Inc. (Dallas, Tex.).

Additional components useful with polyurethanes include chain-extenders, cross-linkers, blowing agents, UV stabilizers, anti-oxidants, pigments, coupling agents, surfactants, and catalysts. Though the use of such components is well known to one of skill in the art, some of these additional additives are further described herein.

Low molecular weight reactants such as chain-extenders and/or cross-linkers can be included in the polyurethane composite materials described herein. These reactants help the polyurethane system to distribute and contain the inorganic filler and/or fibers within the polyurethane composite material. Chain-extenders are difunctional molecules, such as polyols or amines, that can polymerize to lengthen the urethane polymer chains. Examples of chain-extenders include the 1,4-butane diol; 4,4′-Methylenebis (2-Chloroaniline) (MBOCA); and diethyltoluene diamine (DETDA). Cross-linkers are tri- or greater functional molecules that can integrate into a polymer chain through two functionalities and provide one or more further functionalities (i.e., linkage sites) to cross-link to additional polymer chains. Examples of cross-linkers include ethylene glycol, glycerin, trimethylolpropane, and sorbitol. In some polyurethane composites, a cross-linker or chain-extender may be used to replace a portion of the polyol.

Foaming agents (also known as blowing agents) may also be added to the extruder (e.g., to the second section 40) to cause foaming. Examples of blowing agents include organic blowing agents, such as halogenated hydrocarbons, hexanes, and other materials that vaporize when heated by the polyol-isocyanate reaction (such as water, which reacts with isocyanate to yield carbon dioxide). The foaming agent can be added such that the foaming agent initiates a foaming reaction prior to extruding the composite mixture.

Among other parameters, the rate of foaming can be controlled by the temperature of the composite materials when the foaming agent is added or present. For example, increasing the temperature of the composite material when a foaming agent is present increases the foaming reaction. Similarly, cooling the composite material upon addition of foaming agent can reduce the amount of foaming. Cooling the composite material to reduce the amount of foaming is useful when a foaming reaction is desired to be initiated in the extruder and continue once the composite material is extruded from the output end of the extruder. For example, when an extruded composite material is fed into a mold, if the foaming reaction continues, the composite material can expand to fill the mold.

Ultraviolet light stabilizers, such as UV absorbers, can be added to the polyurethane composite material. Examples of UV light stabilizers include hindered amine type stabilizers and opaque pigments like carbon black powder. Antioxidants, such as phenolic antioxidants can also be added. Antioxidants provide increased UV protection, as well as thermal oxidation protection.

Pigments or dyes optionally can be added to the polyurethane composite material. An example of a pigment is iron oxide, which can be added in amounts ranging from about 2 wt % to about 7 wt %, based on the total weight of the composite material.

Catalysts are generally added to control the curing time of the polymer matrix. Examples of useful catalysts include amine-containing catalysts (such as DABCO and tetramethylbutanediamine) and tin-, mercury-, and bismuth-containing catalysts. Multiple catalysts can be used to increase uniformity and rapidity of cure. For example, a mixture of 1 part tin-containing catalyst to 10 parts amine-containing catalyst can be added to a reaction mixture in an amount up to about 0.10 wt % (based on the total reaction mixture).

Surfactants may optionally be used as wetting agents and to assist in mixing and dispersing the inorganic particulate material in a composite. Surfactants also stabilize and control the size of bubbles formed during foaming (if foaming is used) and passivates the surface of the inorganic particulates, so that the polymeric matrix covers and bonds to a higher surface area. Surfactants can be used in amounts below about 0.5 wt % based on the total weight of the mixture. Examples of surfactants useful with the polyurethanes described herein include silicone surfactants such as DC-197 and DC-193 (Air Products; Allentown, Pa.), and other nonpolar and polar (anionic and cationic) products.

Coupling agents and other surface treatments such as viscosity reducers or flow control agents can be added directly to the filler or fiber (pre-treatment), or incorporated prior to, during, and/or after the mixing and reaction of the polyurethane composite material. Coupling agents allow higher filler loadings of an inorganic filler such as fly ash and may be used in small quantities. For example, the polyurethane composite material may comprise about 0.01 wt % to about 0.5 wt % of a coupling agent. Examples of coupling agents useful with the polyurethanes described herein include Ken-React LICA 38 and KEN-React KR 55 (Kenrich Petrochemicals; Bayonne, N.J.).

Variations in the ratio of the polyol to the isocyanate in a reactive mixture may result in variations in the polyurethane composite especially with high inorganic filler loads. Additionally, changes in the polyol to isocyanate ratio may result in changes to the process for making the polyurethane composites. High filler loading in such systems typically inhibits (i.e., physically blocks) the reaction or action of the various polyurethane composite components, including the polyol, the isocyanate, the surfactants, the coupling agents, and the catalysts. Increasing the temperature during processing sometimes helps the reactivity of the reactive mixtures. The use of excess isocyanate, i.e., an isocyanate index above 100, can give higher temperature exotherms during the process of making the polyurethane composite material, which can result in more cross-linking of the polyol and isocyanate, and/or a more complete reaction of the hydroxyl groups and isocyanate groups.

An example of useful compositional ranges (in percent based on the total composite composition) are provided below:

| Component | wt % range |
|---|---|
| Polyol | about 2.5 to about 35 |
| Isocyanate | about 12 to about 15 |
| Catalyst | up to about 0.3 |
| Surfactant | up to about 0.5 |
| Coupling Agent | about 0.01 to about 0.5 |
| Blowing Agent | up to about 0.15 |
| Pigment | up to about 7 |
| Fiber | up to about 10 |
| Filler | about 20 to about 95 |

Additional components as described herein can be added in various amounts that can be determined by persons having ordinary skill in the art.

The present invention is not limited in scope by the embodiments disclosed herein which are intended as illustrations of a few aspects of the invention and any embodiments which are functionally equivalent are within the scope of this invention. Various modifications of the apparatus and methods in addition to those shown and described herein will become apparent to those skilled in the art and are intended to fall within the scope of the appended claims. Further, while only certain representative combinations of the apparatus and method steps disclosed herein are specifically discussed in the embodiments above, other combinations of the apparatus components and method steps will become apparent to those skilled in the art and also are intended to fall within the scope of the appended claims. Thus a combination of components or steps may be explicitly mentioned herein; however, other combinations of components and steps are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

What is claimed is:

1. A method of forming a foamed polyurethane composite material in an extruder, the method comprising:
introducing a polyol, a di- or poly-isocyanate, and an inorganic filler to a first section of an extruder;
mixing the polyol, the di- or poly-isocyanate, and the inorganic filler in the first section to produce a composite material;
advancing the composite material to a second section of the extruder, the second section being maintained at a vacuum pressure;
foaming the composite material in the second section;
extruding the composite mixture from an output end of the extruder,
wherein the vacuum pressure in the second section removes non-foaming related gasses entrained in the composite material.

2. The method of claim 1, wherein the vacuum pressure is maintained using a vacuum source.

3. The method of claim 1, wherein the vacuum pressure is maintained at 1 to 25 inHg.

4. The method of claim 1, wherein the inorganic filler is fly ash.

5. The method of claim 1, further comprising adding fiber in the first section of the extruder.

6. The method of claim 1, further comprising introducing a foaming agent.

7. The method of claim 6, wherein the foaming agent is water.

8. The method of claim 7, wherein the foaming agent initiates a foaming reaction prior to extruding the composite mixture.

9. The method of claim 1, wherein the composite mixture continues to foam after the composite mixture is extruded.

10. The method of claim 1, further comprising cooling the second section to control the rate of foaming.

11. A method of forming a molded article using a foamed polyurethane composition comprising:
introducing a polyol, a di- or poly-isocyanate, and an inorganic filler to a first section of an extruder;
mixing the polyol, the di- or poly-isocyanate, and the inorganic filler in the first section to produce a composite material;
advancing the composite material to a second section of the extruder, the second section being maintained at a vacuum pressure;
foaming the composite material in the second section;
extruding the composite mixture from an output end of the extruder into a mold,
wherein the vacuum pressure removes non-foaming related gasses entrained in the composite material.

12. The method of claim 11, wherein the mold is a continuous mold.

13. The method of claim 11, wherein the vacuum pressure is maintained using a vacuum source.

14. The method of claim 11, wherein the vacuum pressure is maintained at 1 to 25 inHg.

15. The method of claim 11, wherein the inorganic filler is fly ash.

16. The method of claim 11, further comprising adding fiber in the first section of the extruder.

17. The method of claim 11, further comprising introducing a foaming agent.

18. The method of claim 17, wherein the foaming agent is water.

19. The method of claim 11, wherein the composite mixture continues to foam when the composite mixture enters the mold.

20. The method of claim 11, further comprising cooling the second section to control the rate of foaming.
